(19) United States
(12) Patent Application Publication
(10) Pub. No.: US 2022/0203589 A1
(43) Pub. Date: Jun. 30, 2022

(54) Vented Mold Pin

(71) Applicant: Next Chapter Manufacturing Corporation, Grand Rapids, MI (US)

(72) Inventor: Jason Murphy, Grand Rapids, MI (US)

(73) Assignee: Next Chapter Manufacturing Corporation, Grand Rapids, MI (US)

(21) Appl. No.: 17/560,720

(22) Filed: Dec. 23, 2021

Related U.S. Application Data
(60) Provisional application No. 63/130,478, filed on Dec. 24, 2020.

(51) Int. Cl. B29C 45/34; B29C 45/40

(52) U.S. Cl. CPC B29C 45/34; B29C 2045/4021; B29C 45/401

(57) ABSTRACT

A pin for a mold includes a first portion extending from a first end of the pin. The first portion of the pin includes an outer shell that has a first material density that is gas-impervious. The first portion of the pin also includes an inner core extending form the first end that includes a second material density that is gas permeable.

### CROSS REFERENCE TO RELATED APPLICATIONS

This U.S. patent application claims priority under 35 U.S.C. § 119(e) to U.S. Provisional Application 63/130,478, filed on Dec. 24, 2020. The disclosure of this prior application is considered part of the disclosure of this application and is hereby incorporated by reference in its entirety.

### TECHNICAL FIELD

This disclosure relates to vented mold pins.

### BACKGROUND

Injection molding is a manufacturing process that produces plastic parts by injecting molten plastic material into a mold whereby the plastic material solidifies to form the plastic parts. As the plastic material injects into the mold, the plastic material pressurizes air contained inside of the mold. As such, molds often include gaps or vents formed by a split line of steel in the mold that allows the pressurized air to evacuate from the mold to the atmosphere outside of the mold. If the gap or vent in the mold is not large enough, the air is unable to evacuate creates voids or burns on the plastic parts. On the other hand, if a gap in the mold is too large plastic material will solidify in the gap creating flash which is considered a defect in plastic parts.

### SUMMARY

One aspect of the disclosure provides a pin for a mold that includes a first portion extending from a first end of the pin. The first portion of the pin includes an outer shell that includes a first material density that is gas-impervious. The first portion of the pin also includes an inner core extending from the first end that includes a second material density that is gas permeable.

Implementations of the disclosure may include one or more of the following optional features. In some implementations, the inner core includes pores ranging from 5 micron to 100 micron. In some examples, the pin further includes a second portion extending from the first portion to a second end of the pin. The second portion includes a plurality of engagement features formed on an outer surface of the second portion. In these examples, the pin may further include a pin head configured to selectively interface with the engagement features of the second portion. Optionally, the pin head may be further configured to interface with the engagement features of the second portion to adjust an overall length of the pin. The pin head may include one or more set screws configured to clamp the pin head at an adjustable position along the second portion.

In some implementations, the pin further includes a vent chamber disposed within the first portion that. Here, the inner core provides fluid communication between the first end of the pin and the vent chamber. In these implementations, the pin further includes one or more vent slots that extend through the inner core from the first end of the pin to the vent chamber. Each vent slot may include a first width at the first end of the pin. Optionally, a width of each vent slot increases between the first end of the pin and the vent chamber.

In some examples, the first material density is greater than the second material density. The pin may include an H-13 steel material. In some implementations, the pin includes an ejector pin for the mold. In other implementations, the pin includes a core pin for the mold. The first portion of the pin may include an electrical discharge machining (EDM) surface finish.

Another aspect of the disclosure provides a method of manufacturing a mold pin. The method includes forming, using an additive manufacturing process, an inner core that includes a first material density that is gas permeable. The method also includes forming, using the additive manufacturing process, an outer shell surrounding a periphery of the inner core. Here, the outer shell has a second material density that is gas-impervious. Implementations of the disclosure may include one or more of the following optional features. In some implementations, manufacturing the mold pin further includes forming the inner core and the outer shell at a first end of the mold pin wherein an overall length of the mold pin extends from the first end to a second end, trimming a portion of the mold pin at the second end to length of the mold pin, and threading a pin head onto the second end. In these implementations, the method further includes securing the pin head using one or more set screws of the pin head. In some examples, the additive manufacturing process includes three-dimensional printing. The pin may include H-13 steel.

### DESCRIPTION OF DRAWINGS

FIG. 1 is a perspective view of a vented mold pin interacting with a mold.

FIG. 2 is a perspective view of the vented mold pin.

FIG. 3 is an exploded view of the vented mold pin.

FIG. 4 is a cross sectional view of the vented mold pin.

FIG. 5 is a cutaway view of a first portion of the vented mold pin.

FIG. 6 is a schematic view of the vented mold pin integrated with a mold.

FIG. 7 is a schematic view of the vented mold pin.

FIG. 8 is a schematic view of a pin head of the vented mold pin.

FIGS. 9A-9C are perspective views of the pin head interfacing with the vented mold pin.

FIG. 10 is a perspective view of an inner core of the vented mold pin that includes vent slots.

FIG. 10A is an enlarged perspective view of the inner core of the vented mold pin of FIG. 10, taken at Area 10A of FIG. 10.

FIG. 11 is a method of producing the vented mold pin.

FIG. 12 is a perspective view of a mold insert that includes integrated venting.

FIGS. 12A and 12B are enlarged perspective views of the mold insert of FIG. 12, respectively taken at Area 12A and Area 12B of FIG. 12.

Like reference symbols in the various drawings indicate like elements.

### DETAILED DESCRIPTION

Injection molding is a manufacturing process that produces plastic parts by injecting molten plastic material into a mold whereby the plastic material solidifies to form the plastic parts. As the plastic material injects into the mold, the plastic material pressurizes air contained inside of the mold. When the air inside the mold is not evacuated properly, the air creates voids, burns, or other unwanted defects on the plastic parts. As a result, gas trapped in the molds leads to high scrap levels, cracking parts, weak parts, or other part rejections leading to lost profits. Current implementations create vents for the air to evacuate molds through split lines of steel in the mold. For example, a vent may be formed by a split line of steel at an insert, an ejector pin, or where two halves of the mold come together. However, if the mold vents do not vent enough air, the air is still unable to evacuate and the created plastic parts still include unwanted voids or burns. Alternatively, if the mold vents are too large, the molten plastic enters the vents and solidifies thereby creating unwanted excess material (e.g., flash) on the plastic parts.

Implementations herein are directed towards a pin for a mold configured to vent air evacuated from the mold to the atmosphere surrounding the mold. Accordingly, the air evacuates from the mold to minimize voids and/or burns on the plastic parts without allowing flash onto the plastic parts. Notably, implementations described herein generate 10-15 times an amount of venting over current implementations. Moreover, the pins are configurable with standard molds having the industry standard size of ejector pins. Thus, the pins can be placed anywhere in the mold without the need for inserting or other additional costs.

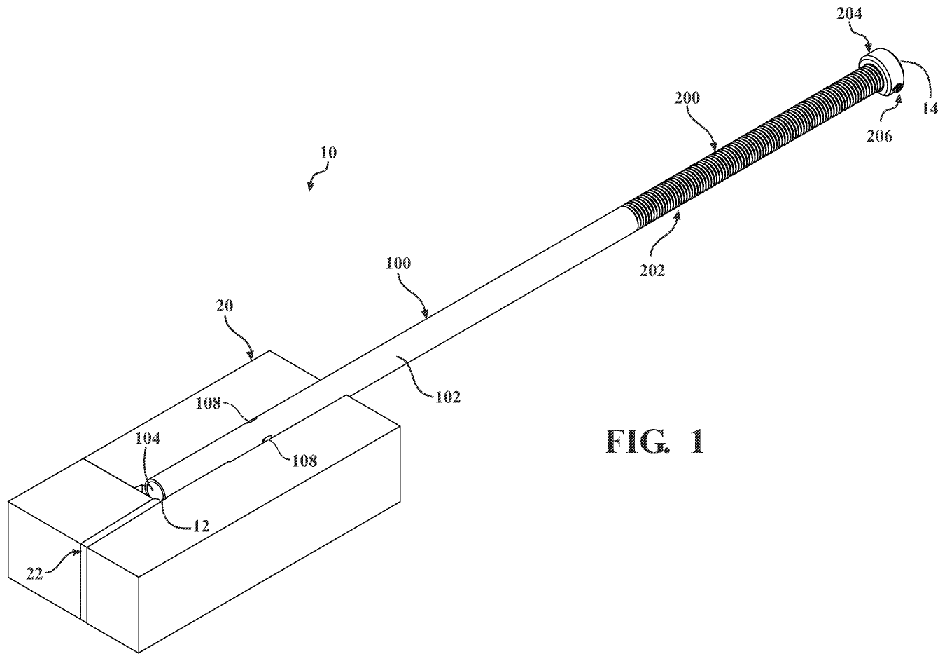

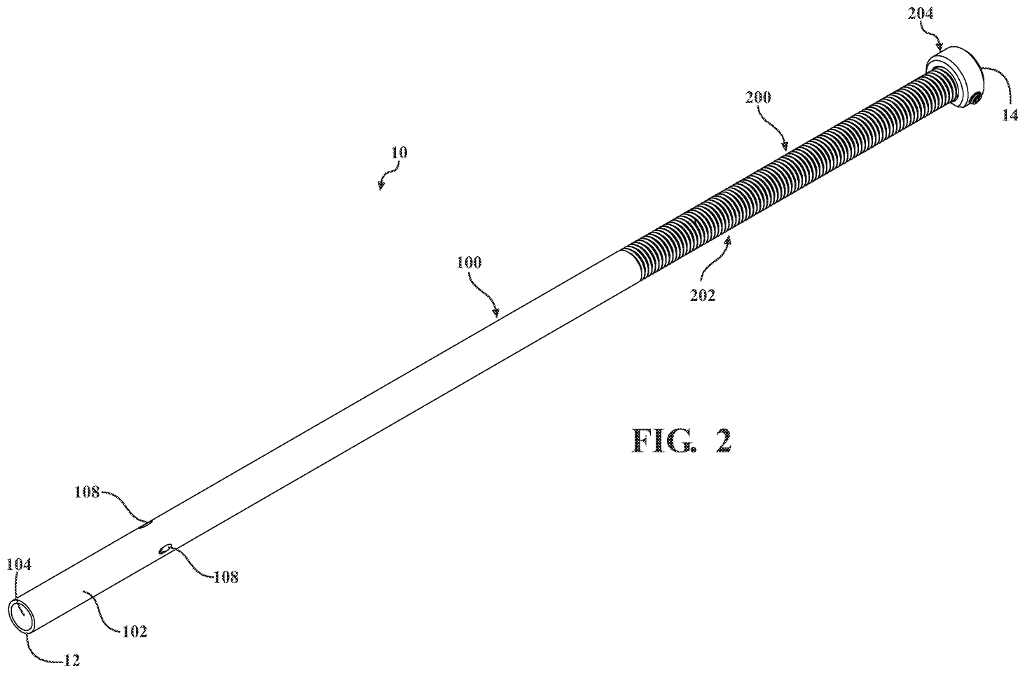

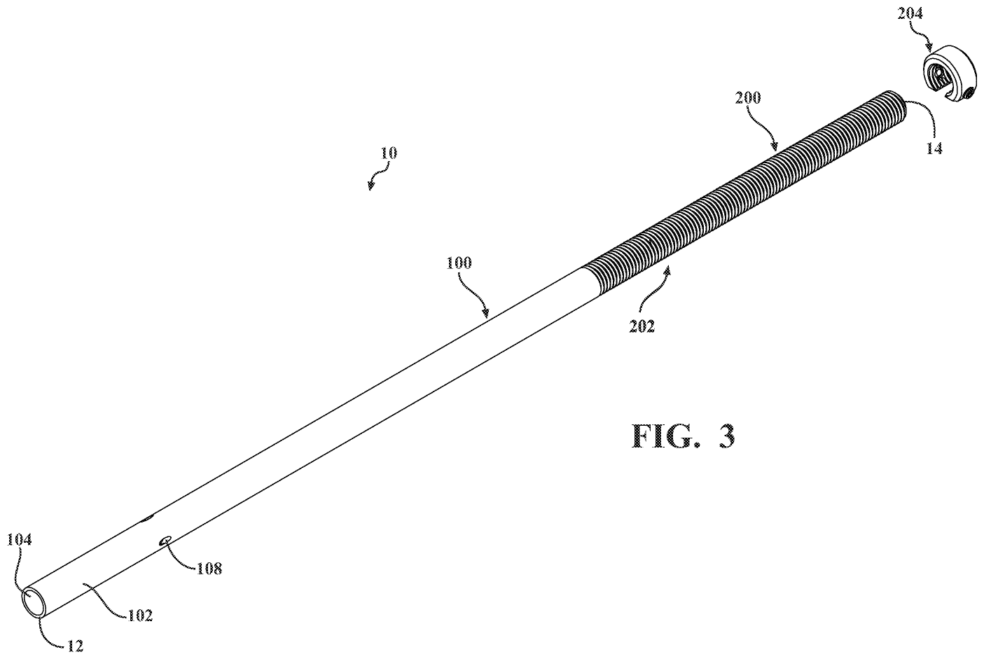

FIGS. 1-10 illustrate an example of a vented mold pin 10 according the present disclosure. In particular, FIGS. 1-5 illustrate perspective views of an example vented mold pin 10 according to the present disclosure. The vented mold pin 10 (also referred to as simply “pin 10”) may be configured for use as an ejector pin or as a core pin for a mold 20. The pin 10 extends from a first end 12 to a second end 14 along a longitudinal axis. A first portion 100 of the pin 10 is disposed at the first end 12 and a second portion 200 of the pin 10 is disposed between the first portion 100 and the second end 14. The first end 12 of the pin 10 may be disposed adjacent to one or more exhaust ducts 22 of the mold 20. The one or more exhaust ducts 22 are configured to allow gases to evacuate the mold 20.

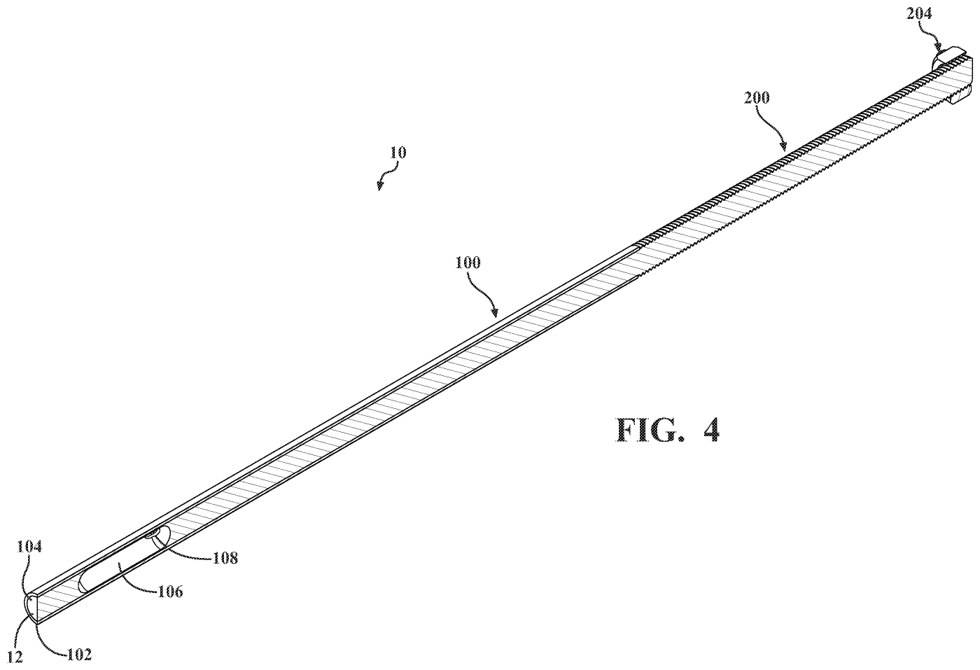

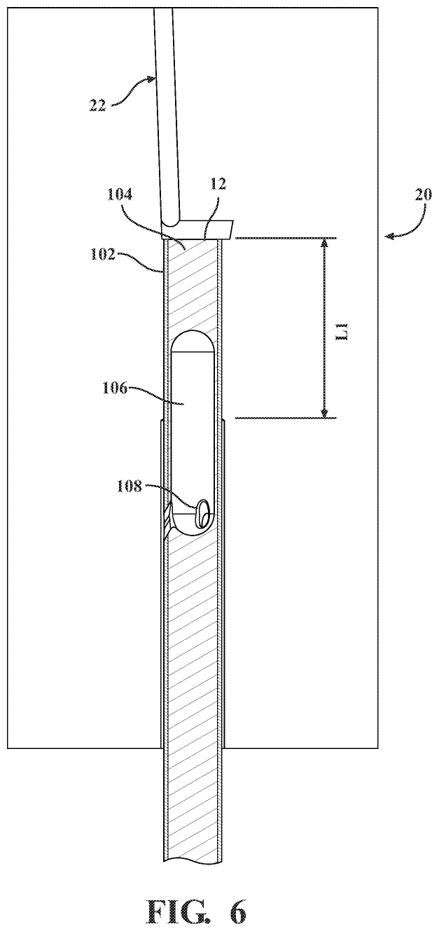

The first portion 100 of the pin 10 shown in the present example includes an outer shell 102 and an inner core 104 surrounded by the outer shell 102. The outer shell 102 includes a gas-impervious metallic material and defines an outer surface of the first portion 100 of the pin 10. The inner core 104 includes a gas permeable material and extends from the first end 12 of the pin 10 to a vent chamber 106 (FIG. 4) formed within the first portion 100. Thus, the inner core 104 is configured to provide restricted fluid and/or gaseous communication between the first end 12 of the pin 10 and the vent chamber 106. The first portion 100 of the pin 10 further includes one or more exhaust ports 108 extending through the outer shell 102 from the vent chamber 106. In other examples, the exhaust ports 108 may extend along the longitudinal axis of the pin 10 from the vent chamber 106 to an exhaust outlet formed through the second end 14 of the pin 10 (as shown in FIG. 6).

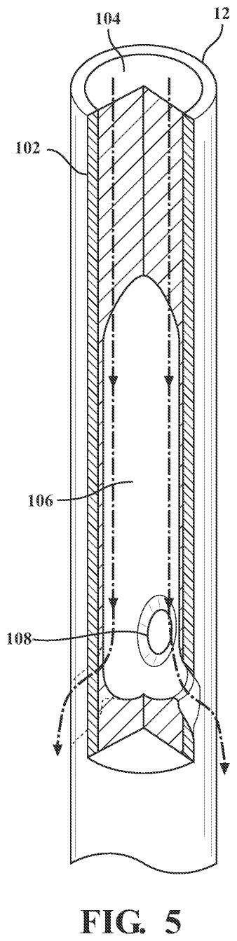

In the example shown, the pin 10 includes, but is not limited to, two exhaust ports 108. That is, the pin 10 may include any number of exhaust ports 108. The exhaust ports 108 are configured to provide fluid or gaseous communication between the vent chamber 106 (FIG. 4) and exhaust ducts 22 formed in a mold 20 of a molding system (e.g., an injection molding system). As shown in FIG. 5, gases from the exhaust ducts 22 (FIG. 1) may pass through outer shell 102 at the first end 12 of the pin 10 (e.g., the face of the pin 10) into vent chamber 106 of the inner core 104, and finally to the atmosphere via the exhaust ports 108. In the example shown, the right dashed arrow denotes gases flowing through a first exhaust port 108 and the dashed arrows on the left denote gases flowing through a second exhaust port 108 (not shown) that is hidden by the cutaway view.

In some examples, the inner core 104 includes a material structure having a lower density than the outer shell 102. Thus, the inner core 104 may include the same material as the outer shell 102, but be formed with a lower density providing a gas permeable, open-cell pore structure. Pore sizes of the inner core 104 range from 5 microns to 100, and more specifically, from 10 microns to 40 microns, and even more specifically, from 20 microns to 30 microns. In some examples, the inner core 104 includes a constant porosity from the first end 12 to the vent chamber 106. In other examples, the inner core 104 may have a variable porosity. For example, the sizes and/or concentration of the pores may increase along a direction from the first end 12 to the vent chamber 106, thereby minimizing the likelihood of clogging the pores at the first end 12 while maximizing fluid flow beneath the first end 12 (e.g., the tip) of the pin 10. The porous inner core 104 allows gases to pass through the face of the pin 10 at the first end 12 and vent out to atmosphere outside of the pin 10 through the exhaust ports 108.

The second portion 200 of the pin 10 extends between the first portion 100 and the second end 14 and includes an outer surface including a plurality of engagement features 202 for selectively securing a pin head 204 to the pin 10. In the illustrated example, the engagement features 202 include male helical threading configure to cooperate with female helical threading (i.e., engagement features) formed on an inside diameter of the pin head 204. However, in other examples, the engagement features 202 may include detents, notches, ribs, or the like. In use, the length of the second portion 200 can be adjusted by a toolmaker to tune the overall length of the pin 10 to the mold 20 such that the first end 12 of the pin 10 is flush with a mold surface of the mold. For example, the second portion 200 may be cut or trimmed from the second end 14 to adjust the overall length of the second portion 200 and the pin 10. When the length of the second portion 200 is cut, the pin head 204 can be selectively secured to the “new” second end 14 by interfacing the engagement features (e.g., the female threads) of the pin head 204 with the engagement features 202 of the second portion 200. Furthermore, the pin head 204 may include one or more set screws 206 for clamping the pin head 204 around the second portion 200 in an adjusted position (e.g., at the “new” second end 14).

Pins 10 according to the present disclosure solve the persistent problem of gas traps in molds where traditional venting methods clog. The pin 10 of the present disclosure provides 10-15 times the volume of venting over traditional venting. These are a drop-in replacement for industry standard mold pin sizes. A full-density (i.e., gas impervious) outer surface of the pin ensures smooth fit and consistent wear and an integrated porous inner core 102 enables gas to pass through the face at the first end 12 of the pin 10 and vent out to atmosphere on the side of the pin through the exhaust ports 108. These pins 10 are suitable for all typical filled and unfilled grades of plastic resin.

FIG. 6 illustrates a schematic view of the example pin 10 integrated within the mold 20. Here, a cross sectional view of the pin 10 shows the vent chamber 106 and the exhaust port 108 of the pin 10. Moreover, the cross sectional view illustrates the outer shell 102 and the inner core 104 of the pin 10. The pin 10 may include a first length L1 from the second end 14 to the vent chamber 106. The first length L1 may be 1 inch in length.

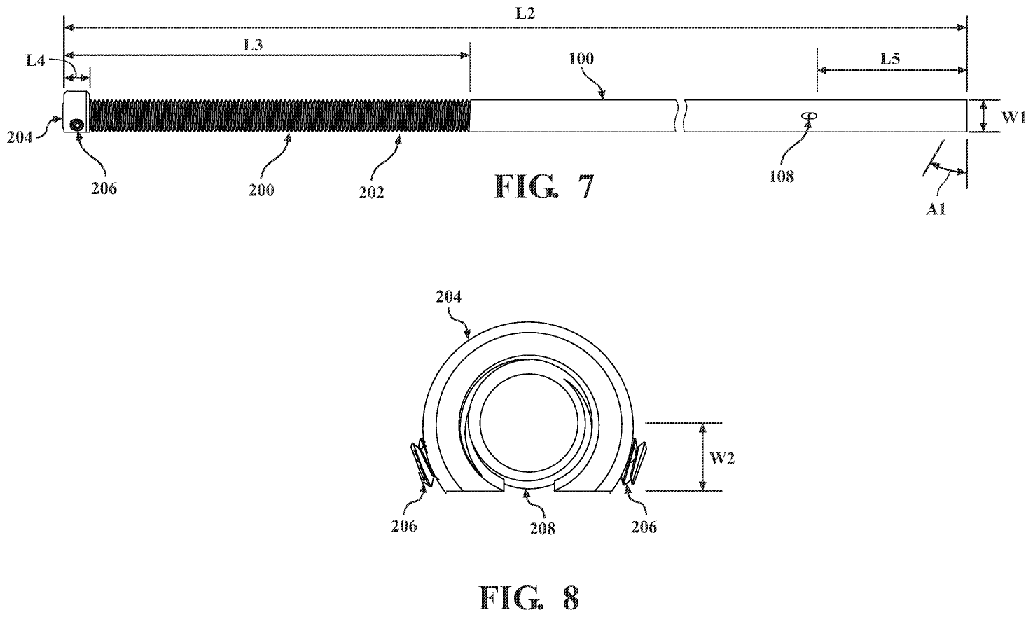

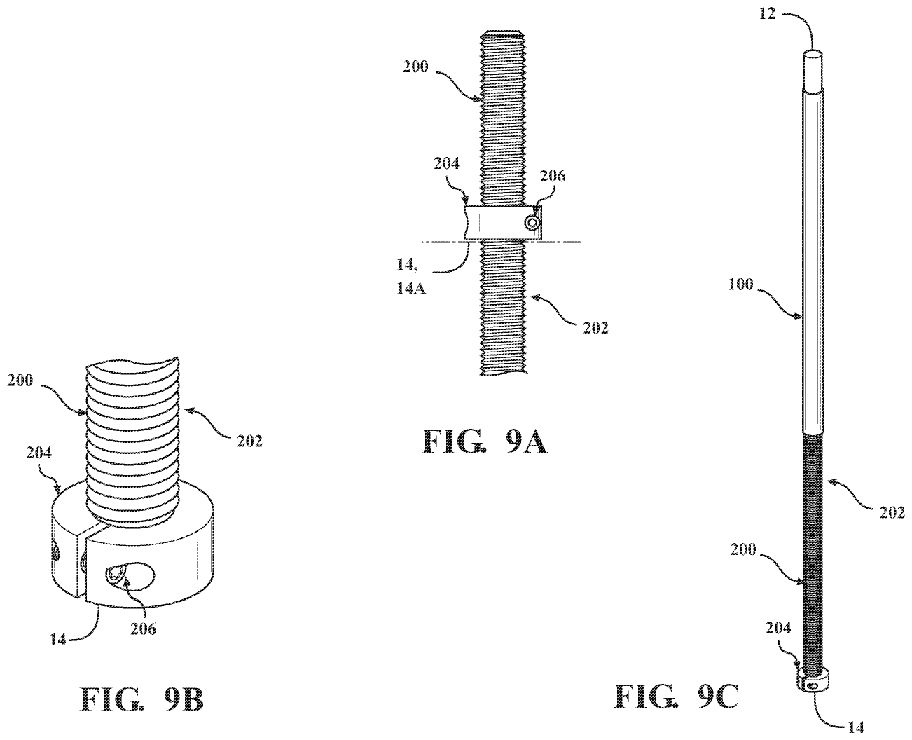

FIGS. 7 and 8 illustrate schematic views of dimensions for the example pin 10 (FIG. 7) and the pin head 204 (FIG. 8). In the example shown, the pin 10 includes a second length L2 from the first end 12 to the second end 14. The second length L2 may include a length of 11 inches. The pin 10 also has a third length L3 denoting the length of the second portion 200. The third length L3 may include a length of 4 inches. The pin head 204 includes a fourth length L4 denoting a thickness of the pin head 204. In some implementations, the fourth length L4 ranges from 0.187 to 0.25 inches. Moreover, the pin 10 includes a fifth length L5 from the first end 12 of the pin to a bottom side of the exhaust port 108. Here, the fifth length L5 may be 1.48 inches.

In some implementations, the pin 10 includes a first width W1 denoting a diameter of the pin 10. In these implementations, the first width W1 may include a range from 0.1870 to 0.5050 inches. The pin 10 also includes a first angle A1 denoting a contour at the first end 12 of the pin 10. Here, the first angle may include a 30 degree angle. Referring now to FIG. 8, the pin head 204 includes a second width W2 denoting a radius of the pin 10. That is, the second width W2 is equal to one-half of W1 (e.g., the diameter of the pin 10). Thus, the second width W2 includes a range of 0.0935 to 0.2525 inches. FIG. 8 also illustrates the engagement features 208 (e.g., the female threads) on the inter diameter of the pin head 204 configured to interface with the engagement features (e.g., male threads) of the second portion 200 of the pin 10.

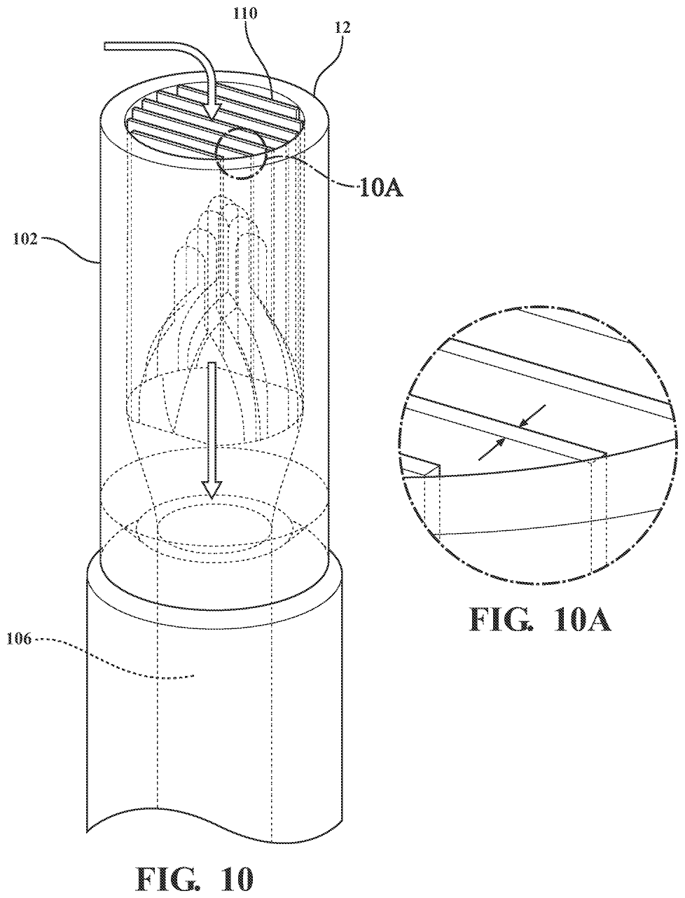

FIGS. 9A-9C illustrate the pin head 204 interfacing with the engagement features of the second portion 200 of the pin 10. In particular, as the pin head 204 rotates in a clockwise direction about the longitudinal axis, the pin head 204 translates in a first direction along the second portion 200. Moreover, as the pin head 204 rotates in a counterclockwise direction along the longitudinal axis, the pin head 204 translates in an opposite, second direction along the second portion 200. Accordingly, an operator (e.g., toolmaker) can rotate the pin head 204 to adjust the second end 14 of the pin 10. As shown in FIG. 9A, the pin head 204 is disposed at a location along the second portion 200 defining an adjusted second end 14, 14A of the pin 10. Once the operator has the adjusted second end 14A at a desired position, the pin head 204 is secured in place using the one or more set screws 206.

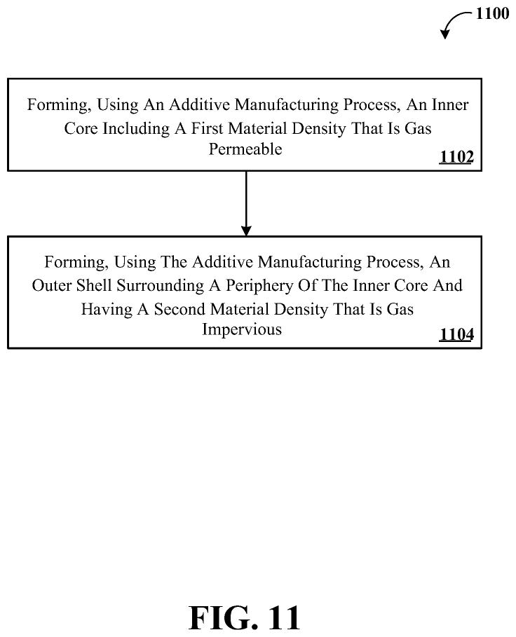

Referring now to FIG. 10, in some implementations, the inner core 104 may additionally or alternatively include vent slots 110 extending through the inner core 104 from the first end 12 of the pin 10 to the vent chamber 106. In some examples, the vent slots 110 may have a first width at the first end 12 configured minimize flow of a molding material (e.g., resin) into the inner core 104. Optionally, the widths of the vent slots 110 may increase between the first end 12 and the vent chamber 106 to maximize flow of the exhausted gas. FIG. 10A illustrates an expanded view of one of the vent slots 110. In the example shown, the vent slot 110 includes a third width of W3. Here, the third width W3 may include a range of 0.0005 to 0.005 inches.

In use, the pins 10 are implemented in molds 20 in areas where a gas trap or burning is present on plastic parts to enable the gas to exhaust out efficiently. The pins 10 can also be placed at end of fill under the part to provide venting where parting line vents can become blocked or coined over. Placing these pins 10 under a screw boss or the bottom of a rib are common plastic part features that are critical areas for plastic to be of highest integrity.

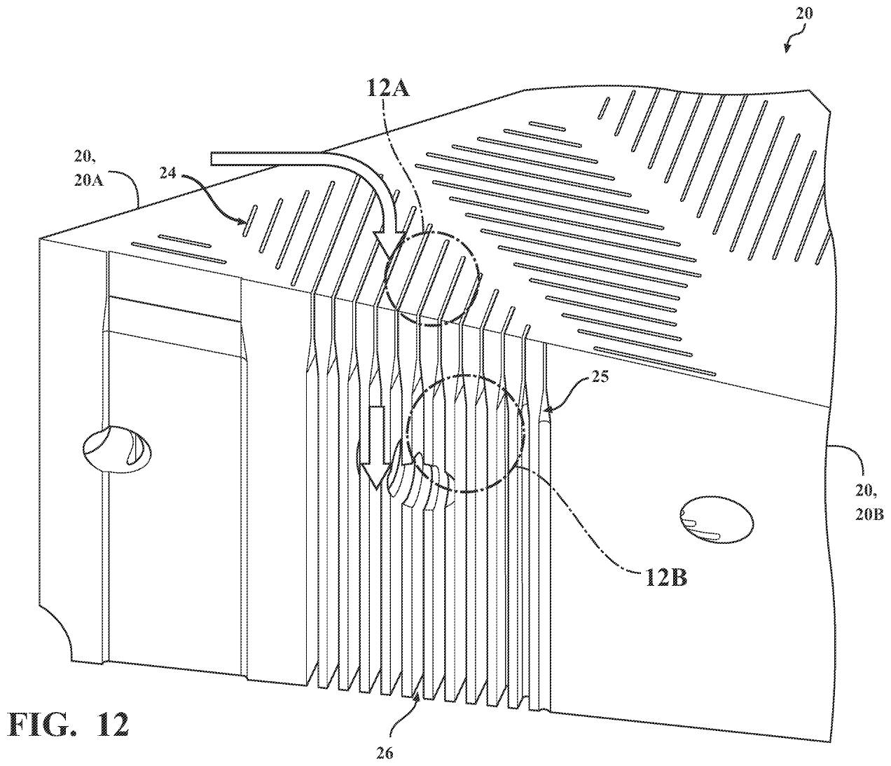

FIG. 11 illustrates an example arrangement of operations for method 1100 of manufacturing an example pin 10 as described in this disclosure. At operation 1102, the method 1100 includes forming, using an additive manufacturing process, an inner core 102 of the pin 10 that includes a first material density that is gas permeable. In particular, the additive manufacturing process (e.g., three-dimensional printing) may produce the pin 10 according to the dimensions described in this disclosure or any other suitable custom pin 10 dimensions. In some examples, the additive manufacturing produces the pin 10 with a conventional tool steel, such as an H-13 steel or stainless steel material. At operation 1104, the method 1100 includes forming, using the additive manufacturing process, an outer shell 104 of the pin 10 surrounding a periphery of the inner core 102. Here, the outer shell 104 has a second material density that is gas impervious. In some implementations, forming the inner core 102 and the outer shell 104 at a first end 12 of the pin 10 includes an overall length of the pin 10 extending from the first end 12 to a second end 14 of the pin 10.

Optionally, the method 1100 may further include trimming a portion of the pin 10 at the second end 14 of the pin 10. Trimming the portion of the pin 10 allows a user (e.g., toolmaker) to adjust the overall length of the pin 10. Moreover, the method 1100 may further include threading a pin head 204 onto the second end 14 of the pin 10. Threading the pin head 204 onto the second end 14 adjusts the overall length of the pin 10. Once the operator threads the pin head 204 to a position along the second portion 200 of the pin 10, the operator secures the pin head using one or more set screws 206 of the pin head 204.

In some implementations, the pin 10 is formed using a laser sintering process, which works by building the inserts additively using steel powder that is fused together with a laser to create solid steel that is full density of typical steel. Using laser sintering, the porous inner core 104 and/or vent slots 110 can be placed anywhere in the pin 10 without need for inserting or additional cost.

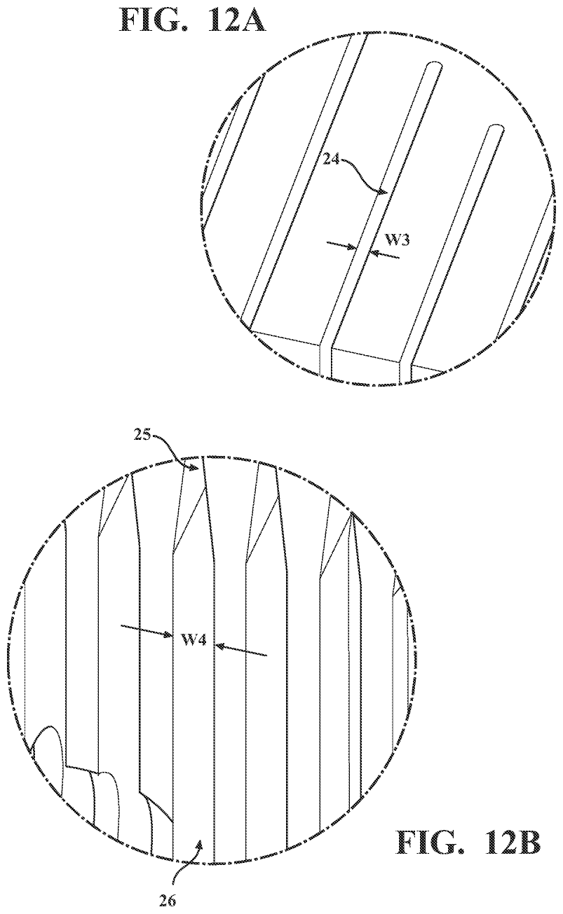

Implementations herein are further directed toward a mold 20 with integrated venting. The mold 20 with integrated venting may be used additionally or alternatively to the vented mold pin 10 described above. Referring now to FIG. 12, the mold 20 may include a top surface 20, 20A and one or more side surfaces 20, 20B. The top surface 20A includes a plurality of narrow slots 24. As shown in FIG. 12A, an expanded view of the narrow slots 24 includes a narrow slot width W3. The narrow slot width W3 includes a range of 0.0005 to 0.005 inches in width. The narrow slots 24 continue from the top surface 20A to the one or more side surfaces 20B and couple with slots 26 at a transition region 25. The slots 26 extend from the transition region 25 through a bottom surface of the mold 20. As shown in FIG. 12B, an expanded view of the slots 26 includes a slot width W4. The slot width W4 may include a range of 0.02 to 0.06 inches in width. Accordingly, gases may evacuate from the top surface 20A through the narrow slots 24 and the slots 26 to evacuate the mold 20. Simply put, the gases evacuate from the mold 20 to the atmosphere surrounding the mold 20.

A number of implementations have been described. Nevertheless, it will be understood that various modifications may be made without departing from the spirit and scope of the disclosure. Accordingly, other implementations are within the scope of the following claims.

What is claimed is:

1. A pin for a mold, the pin comprising:
a first portion extending from a first end of the pin and including an outer shell including a first material density that is gas-impervious and an inner core extending from the first end and including a second material density that is gas permeable.

2. The pin of claim 1, wherein the inner core includes pores ranging from 5 micron to 100 micron.

3. The pin of claim 1, further comprising a second portion extending from the first portion to a second end of the pin, the second portion further comprising a plurality of engagement features formed on an outer surface of the second portion.

4. The pin of claim 3, further comprising a pin head configured to selectively interface with the engagement features of the second portion.

5. The pin of claim 4, wherein the pin head is further configured to interface with the engagement features of the second portion to adjust an overall length of the pin.

6. The pin of claim 4, wherein the pin head comprises one or more set screws configured to clamp the pin head at an adjustable position along the second portion.

7. The pin of claim 1, further comprising a vent chamber disposed within the first portion, the inner core providing fluid communication between the first end of the pin and the vent chamber.

8. The pin of claim 7, further comprising one or more vent slots extending through the inner core from the first end of the pin to the vent chamber.

9. The pin of claim 8, wherein each vent slot includes a first width at the first end of the pin.

10. The pin of claim 8, wherein a width of each vent slot increases between the first end of the pin and the vent chamber.

11. The pin of claim 1, wherein the first material density is greater than the second material density.

12. The pin of claim 1, wherein the pin includes an H-13 steel material.

13. The pin of claim 1, wherein the pin comprises an ejector pin for the mold.

14. The pin of claim 1, wherein the pin comprises a core pin for the mold.

15. The pin of claim 1, wherein the first portion of the pin comprises an electrical discharge machining (EDM) surface finish.

16. A method of manufacturing a mold pin, the method comprising:
forming, using an additive manufacturing process, an inner core including a first material density that is gas permeable; and
forming, using the additive manufacturing process, an outer shell surrounding a periphery of the inner core and having a second material density that is gas-impervious.

17. The method of claim 16, wherein manufacturing the mold pin further comprises:
forming the inner core and the outer shell at a first end of the mold pin, wherein an overall length of the mold pin extends from the first end to a second end;
trimming a portion of the mold pin at the second end to length of the mold pin; and
threading a pin head onto the second end.

18. The method of claim 17, further comprising securing the pin head using one or more set screws of the pin head.

19. The method of claim 16, wherein the additive manufacturing process comprises three-dimensional printing.

20. The method of claim 16, wherein the pin comprises H-13 steel.
